(19) United States
(12) Patent Application Publication
(10) Pub. No.: US 2012/0296727 A1
(43) Pub. Date: Nov. 22, 2012

(54) INCENTIVIZING SAFE DRIVING BEHAVIORS

(76) Inventors: Adrlan GORE, (US); Barry Swartzberg, (US)

(21) Appl. No.: 13/472,571

(22) Filed: May 16, 2012

(30) Foreign Application Priority Data
May 16, 2011 (ZA) 2011/03580

(51) Int. Cl. G06Q 30/02

(52) U.S. Cl. 705/14.27

(57) ABSTRACT

A computer is used to receive data, including an amount of fuel to which a fuel benefit will apply, and a nominated price for the fuel for a future period, from a driver of a motor vehicle. During the future period, or after the future period has passed, purchase data is received, including a quantity of fuel purchased by the driver during the period, and a price paid for the purchased fuel. The purchase price is compared with the nominated price, and if the purchase price is higher than the nominated price, a refund is issued to the driver of at least a portion of the difference between the purchase price and the nominated price, for at least some of the quantity of fuel purchased.

### CROSS-REFERENCE TO RELATED APPLICATIONS

This application claims priority to South African Patent Application Number 2011/03580 filed May 16, 2011, the contents of which are hereby incorporated by reference.

### FIELD OF THE INVENTION

The present invention relates to a method of managing a fuel related rewards program, and more particularly reimbursing a portion of fuel costs for safe driving behaviors.

### BACKGROUND

A poorly maintaining vehicle, or degraded or inadequate driver skill, tends to increase the probability of a vehicular accident, together with its attendant harms. Drivers suffer potential injury or death. Employers suffer loss of productivity, damage to equipment, liability to others, and the sadness attendant to harm to a team member. Insurers suffer increased claims.

### SUMMARY OF THE INVENTION

According to one example embodiment of the disclosure, there is provided a method of managing a fuel related reward program, the method including receiving data including an amount of fuel to which a fuel benefit will apply and a nominated price for the fuel for a future period from a driver of a motor vehicle; during the future period or after the future period has passed, receiving purchase data including a quantity of fuel purchased by the driver during the period and a price paid for the purchased fuel; comparing the purchase price with the nominated price; and if the purchase price is higher than the nominated price refunding the driver at least a portion of the difference between the purchase price and the nominated price for at least some of the quantity of fuel purchased.

The method may further include receiving data including information relating to the compliance of the driver in a plurality of program areas related to motor vehicle driver behaviors and storing the data in a database; awarding points to the driver wherein the points allocated are related to the compliance of the driver in the program areas; and using the points allocated to alter the amount of the refund to the driver.

In further embodiments, the points allocated may be used to award a driver status, wherein the driver status is used to alter the amount of the refund to the driver; the plurality of program areas may include at least some of vehicle maintenance, driver education, vehicle insurance claims and driving performance; the plurality of program areas may include all of vehicle maintenance, driver education, vehicle insurance claims and driving performance; the program area of vehicle maintenance includes one or more of servicing the vehicle, checking the vehicle and checking the vehicles tires; the program area of driver education includes one or more of a driving course, a driver assessment, a periodic driver quiz and a carbon footprint calculation; the he program area of vehicle insurance claims includes the number of claim free years; and the program area of driving score includes monitoring the manner in which the motor vehicle is driven.

According to another example embodiment, there is provided a system for managing a driver rewards program, the system including a receiving module for receiving data including an amount of fuel to which a fuel benefit will apply and a nominated future price for the fuel for a future period from a driver of a motor vehicle, the receiving module further during the future period or after the future period has passed, receiving purchase data including a quantity of fuel purchased by the driver during the period and a price paid for the purchased fuel; and a calculation module for comparing the purchase price with the nominated price and if the purchase price is higher than the nominated price calculating a refund for the driver of at least a portion of the difference between the purchase price and the nominated price for at least some of the quantity of fuel purchased.

In various embodiments, the receiving module for receives data relating to the compliance of a driver in a plurality of program areas related to motor vehicle driver behaviors; and the calculation module to award points to the driver wherein the points allocated are related to the compliance of the driver in the program areas and to use the points allocated to alter the amount of the refund to the driver.

In further embodiments thereof, the calculation module may use the points allocated to determine a driver status, wherein the driver status is used to alter the amount of the refund to the driver; the plurality of program areas includes at least some of vehicle maintenance, driver education, vehicle insurance claims and driving performance; the plurality of program areas includes all of vehicle maintenance, driver education, vehicle insurance claims and driving performance; the program area of vehicle maintenance may include one or more of servicing the vehicle, checking the vehicle and checking the vehicles tires; the program area of driver education may include one or more of a driving course, a driver assessment, a periodic driver quiz and a carbon footprint calculation; the program area of vehicle insurance claims may include the number of claim free years; the program area of driving score may include monitoring the manner in which the motor vehicle is driven.

In yet further embodiments, the receiving module obtains driver data from a device associated with a motor vehicle; and the analysing module analyses the data to determine the manner in which the motor vehicle has been driven for a past period.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, in which:

FIG. 1 is a block diagram illustrating an exemplary system for implement the methodologies of the disclosure;

FIG. 2 illustrates an example system environment in which an embodiment of the disclosure is implemented;

FIG. 3 is a block diagram illustrating an example embodiment of the disclosure; and

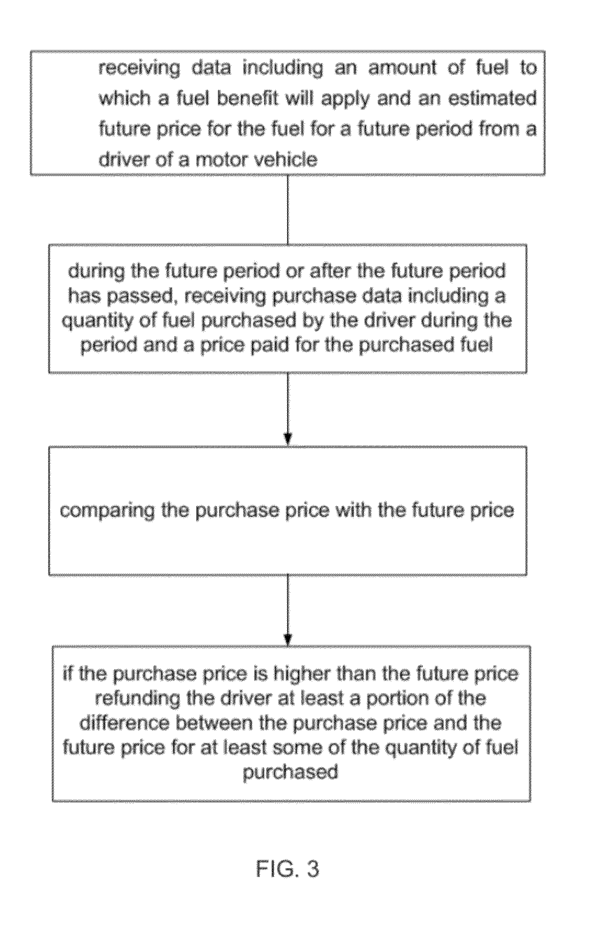

FIG. 4 illustrates a system architecture for a computer system such as a server, work station or other processor on which the disclosure may be implemented.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language).

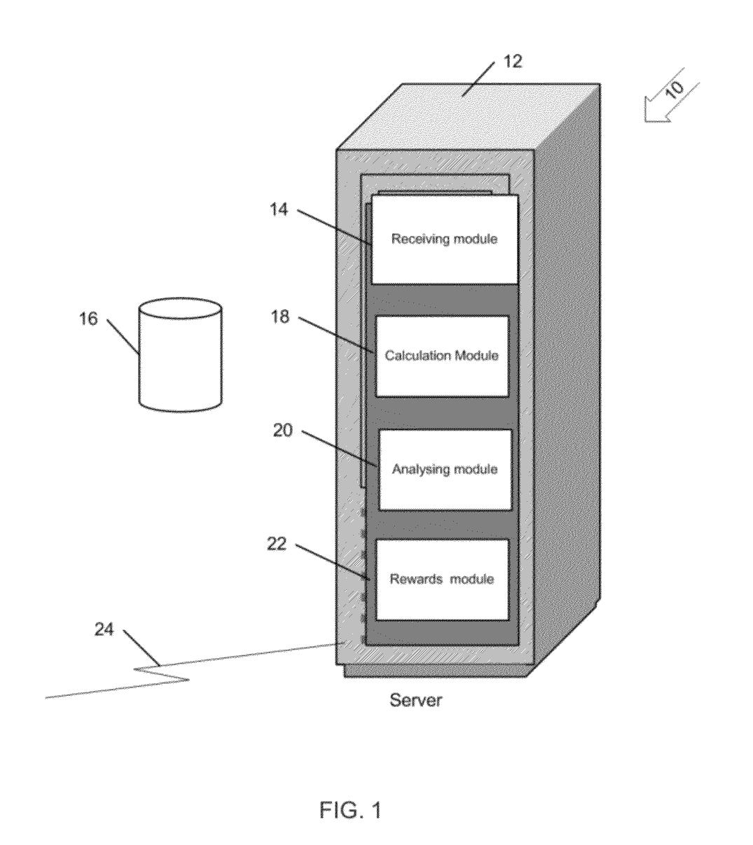

The present disclosure relates to a method of implementing a fuel related reward for a driver of a motor vehicle and to a system therefor. Referring to FIG. 1, an information processing system 10 may include a server 12 that includes a number of modules to implement an example embodiment.

In one example embodiment, the modules described below may be implemented by a computer connected to a machine-readable medium embodying instructions which, when executed by the computer, cause the computer to perform any of the methods described above. In another example embodiment the modules may be implemented using firmware programmed specifically to execute the method described herein.

It will be appreciated that embodiments of the present disclosure are not limited to such architecture, and could equally well find application in a distributed, or peer-to-peer, architecture system. Thus the modules illustrated could be located on one or more servers operated by one or more institutions. It should also be appreciated that in any of these cases the modules form a physical apparatus with physical or virtual modules specifically for executing the steps of the method described herein.

In the illustrated example embodiment, the server 12 includes a receiving module 14 to receive data and to write the data to a memory 16. The memory 16 is typically in the form of a database associated with the server 12. The receiving module 14 receives data including an amount of fuel to which a fuel reward will apply and a nominated future price for the fuel for a future period from a driver of a motor vehicle.

In one example the amount of fuel to which the fuel benefit will apply is expressed in litres, although any other unit of measure, such as gallons, may be used. This amount is typically selected by the driver for the future period. Thus, if the future period is a month the driver may select 50 litres or 100 litres, for example. In addition, in one example embodiment the nominated price for fuel could be stated in absolute terms such as an amount in Rands and cents per litre of fuel or in relevant terms such as an amount in Rands or dollars and cents higher than a current fuel price.

It will be appreciated that the driver may transmit this information to the server 12 using a computer and a communications network such as the internet for example, or using any other suitable communications channel, including a handheld wireless device. Alternatively, the driver may inform a third party of their selections and the third party could transmit this information to the server 14 directly or indirectly.

During the future period or after the future period has passed, the receiving module 14 receives purchase data including a quantity of fuel purchased by the driver during the period and a price paid for the purchased fuel. In one example embodiment, this is achieved by issuing the driver with one of a credit card, a debit card and a rewards card.

The credit or debit card will be used to purchase the fuel and in the process the quantities and price of purchased fuel will be captured. Alternatively or in addition the rewards card will be swiped (electronically read) at the point of purchase of fuel, and the quantities and price of purchased fuel will be captured in this manner. In any event, this information is transmitted to the receiving module 14 which stores this data in the database 16.

At some time after the future period, a calculation module 18 compares the purchase price with the nominated price selected by the driver and if the purchase price is higher than the nominated price an amount of a refund for the driver is calculated being at least a part of the difference between the purchase price and the nominated price for the quantity of fuel purchased.

Thus, in an illustrative example, if the nominated price selected by the driver is R10 per litre and the amount of litres the benefit is to apply to is 100 litres, and the driver actually purchased 100 litres at R11 per litre during the selected period, the amount of the refund will be R100. It will be appreciated that if the driver actually purchased 120 litres at R11 per litre during the selected period, the amount of the refund will still be only R100 as they only selected the benefit to apply to 100 litres. If the driver only purchased 80 litres during the selected period, the amount of the refund will be only R80.

In addition, the pump price of fuel is made up of various components such as oil, taxes and distribution costs. In one example embodiment, the above method is applied to only some of these components. For example, a change in the oil price or Rand/Dollar exchange rate could trigger a fuel rebate whereas a similar change in tax may not trigger the rebate.

In one example embodiment, the above method is implemented in conjunction with a rewards program. In this example embodiment, the receiving module 14 receives compliance data containing information relating to the compliance of a driver in a plurality of program areas related to motor vehicle driver behavior. The compliance data is stored in the database 16. An analysing module 20 analyses the compliance data to determine driver behavior. This will be described in more detail below.

The calculation module 18 awards points to the driver wherein the points allocated are related to the compliance of the driver in one or more of the program areas. An example of this is described below. Finally, the points allocated are used by the calculation module 18 to determine the refund.

The plurality of program areas includes at least some of vehicle maintenance, driver education, vehicle insurance claims, premium payments, policy updates and driving performance. In one example embodiment, the plurality of program areas includes all of the abovementioned program areas. The program area of vehicle maintenance includes one or more of servicing the vehicle, checking the vehicle and checking the vehicles tires.

To describe these program areas in more detail, servicing the vehicle means that the driver has taken the vehicle to a mechanical workshop for a periodic or non-periodic service to ensure that the vehicle is in good working order. Typically in such services, oil and other lubricants are changed, brake pads are changed if required, and any other mechanical faults that have arisen in the past period are fixed.

The program area of checking the vehicle entails taking the vehicle to an authorised center were a number of checks on the different parts of the vehicle are conducted to ensure that the vehicle is in good working order. If anything is found to be not correct, the driver will be instructed to take the vehicle to a workshop for fixing and may be awarded further points for this step. New vehicles may be exempt from the service check for the first year and the insured person will be awarded these points on submission of proof that the vehicle is within its first year since its first registration.

Checking the vehicle tires entails either having the tires checked as part of the above-mentioned checking of the vehicle or alternatively, taking the vehicle to a specialist tire center to have the tires checked.

In one example embodiment, an interface is created between the server 12 and checking center via the communications network 24, so that the checking center can confirm the results of the check. In addition to the tire check, the steering, windscreen wipers, lights, seatbelts, horn and shock absorbers can be checked at this time. Bonus Points can be awarded for all of these being in an acceptable condition. In all of these cases, the party doing the checking or servicing will capture data relating to the vehicle and/or driver and periodically transmit this data to the receiving module 14.

The program area of driver education includes one or more of a driving course, a driver assessment, a periodic driver quiz and a carbon footprint calculation. Driving courses are attended by drivers to improve their driving skills and particularly to learn so-called defensive driving skills. A driver assessment is conducted, in one example embodiment, by an assessor taking the driver in the vehicle onto the road, and assessing the driving skills and habits of the driver.

Weaknesses in the skills or habits of the driver may be pointed out and the driver may be given the opportunity to correct these in the coming weeks or months, before returning for an updated assessment. In one example, the driver is given an assessment score.

In another example, the driver assessment is an online questionnaire designed to highlight certain risks relating to a driver. In this example, the questionnaire includes two sections, namely, ‘Driving habits’ and ‘State of Vehicle’. For example, a question of whether one uses a cellular telephone to send messages while driving will be asked. At the end of the questionnaire (approximately 20 questions, for example) the driver will receive feedback explaining their risk and suggesting ways to mitigate their risks.

Based on the answers received, a calculation will be performed to consider the driver's risk relative to an average driver. The results can be illustrated to the driver on a graph showing two risk bars, where one bar illustrates how risky the driver's habits are, and the other illustrates risks relating to the state of the drivers vehicle. A third risk bar may also be included, illustrating a combined risk score.

In addition, the questionnaire may include educational information to address specific areas such as how to drive in wet weather, or what to do in the event of an accident. The format advantageously has the form of a paragraph, followed by a question relating to the paragraph. In this example, the driver may advantageously use a user interface device in the form of a computer with a screen on which is displayed a template for the driver to capture answers to questions posed.

The answers are captured and transmitted to the server 12. Alternatively, the server 12 accesses driver information stored in the database 16 and obtains the driver's e-mail address. An e-mail is then sent to the retrieved e-mail address. When the driver opens the e-mail a template is displayed to them asking them the relevant questions with options to select various scores. A driver will send the e-mail back to the server 12 via a communications network and the receiving module 14. These will be received and written to the database.

The program area of premium payments relates to the quantum and frequency with which the premium payments are made on an insurance policy for the motor vehicle, and if the payments are made on time or not. The program area of policy updates relates to whether or not the driver is updating their policy to accurately reflect what is being insured. The program area of vehicle insurance claims includes the number of claim free years; no-fault claims, where the driver was not at fault, typically will not be calculated as a claim with respect to this. The program area of driving score includes monitoring the manner in which the motor vehicle is driven.

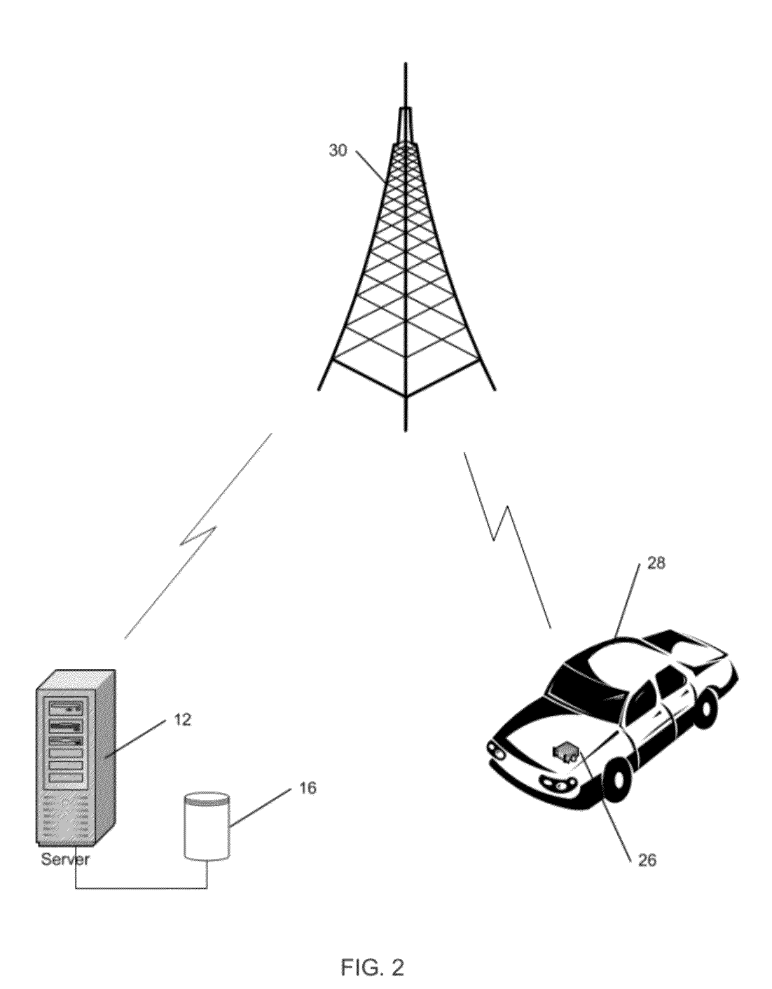

In one example embodiment, the foregoing is implemented using data received from a telematics or telemetry device 26 associated with the vehicle 28 which is the vehicle that is insured on the insurance policy. It will be appreciated that in one example, the telemetry device 26 will be installed in the motor vehicle either at the time of production, or may be retro-fitted. In any event, referring to FIG. 2, a motor vehicle 28 is fitted with the telemetry device 26.

The telemetry device 26 is used to monitor a number of aspects of the use of the motor vehicle. For example, the device monitors the speed at which the vehicle is travelling and can therefore calculate average speed and maximum and minimum speeds, for example. Where the device includes GPS functionality, for example, the device is able to determine if speed limits on a particular road have been exceeded. The device is also able to determine braking habits of the driver either using the GPS functionality or by using an accelerometer or having one or more sensors connected to the vehicle or to a deceleration detection device, for example.

The device is also typically able to detect the distance traveled and if the driver has driven the vehicle for a long time period without a break. In addition, the times of the day that the vehicle is being driven can be captured as night time driving is statistically more dangerous than day time driving, especially weekend late night driving.

In addition to the above, the device will have the ability to detect the driver's use of the vehicle including braking, indicating, cornering and accelerating to name a few examples. Thus it could be determined when the vehicle turns without indicating, for example. In any event, the data from the device is transmitted to the server 12 over a communication network 30.

It will be appreciated that this could be accomplished in a number of ways. For example, the data could be transmitted via a communication network 30 as illustrated in the accompanying drawing. This communication network could be any suitable kind of communication network such as a mobile communication network, a wireless communication network, a satellite communication network or a combination of these, to name but a few examples.

Alternatively, the device 26 could be connected to another intermediate device which downloads the data and transmits the data via the communication network 30 to the server 12. One example of this could be connecting the device 26 to a USB port of a computer and downloading the data to the computer, which data is then transmitted over the Internet to the server 12. In one example embodiment, the data is transmitted over a mobile phone network using the short message service (SMS) protocol.

It will be appreciated that the data could be transmitted at any suitable time to the server. For example, the data could be transmitted in real time or near real time or could be transmitted periodically such as daily, weekly or monthly, to name a few examples. Once the server 12 receives the data it will analyse the data to determine the manner in which the motor vehicle has been driven for a past predetermined period. To do this, an analysing module 20 accesses the memory 16, and retrieves the data stored therein.

The retrieved data is then used to determine a driving score. For example, the driver starts on a higher number of points which is reduced for each driving infraction, such as each harsh braking, speeding or late night driving instance as can be predetermined by the system managers. Alternatively, points may be accumulated, but for safer practices. An example of how the calculation module 18 then awards points appears in Table 1. It should be appreciated that the actual number of points allocated may change and other categories may be introduced.

TABLE 1
Points Awards

| DRIVER CATEGORY | POINTS | FREQUENCY |
|---|---|---|
| DRIVING SCORE | | |
| No Star (no telematics device) | — | Monthly |
| ** | 100 | Monthly |
| *** | 350 | Monthly |
| **** | 800 | Monthly |
| ROADWORTHINESS | | |
| Annual Service | 50 | Annually |
| Multi Point Check | 50 | Annually |
| Multi Point Check Bonus Points | 100 | Annually |
| EDUCATION | | |
| Defensive Driving Course | 150 | Every 3 years |
| Driver Assessment | 50 | Annually |
| Quarterly Quiz | 75 | Quarterly |
| Carbon Footprint Calculated | 50 | Monthly |
| CLAIM FREE YEARS | | |
| 1 | 25 | Monthly |
| 2 | 50 | Monthly |
| 3+ | 100 | Monthly |

In one example embodiment the number of points is used to determine a driver status. An example driver status is presented in Table 2. It should be appreciated that the way in which the points are allocated and driver status determined could be varied. However, in an example embodiment the status will be determined periodically, for example every month.

TABLE 2
Driver Status
DRIVER STATUS

| | |
|---|---|
| Red | 0 |
| Amber | 300 |
| Green | 600 |
| Double Green | 1000 |

At the beginning of every calendar month, or some other predetermined period, the drivers' points are zeroed, and drivers will then be awarded points for having done a multi point check, annual service, driver assessment or carbon footprint calculation within the previous 12 months. Similarly quarterly quiz points will be awarded provided the questionnaire has been done for that quarter. Defensive driving courses need to be completed every 3 years, or any other specified period, to earn points, and if a defensive driving course has been completed in the past 3 years, then the relevant points will be added to the driver score for the present month. If confirmation of these point earning events are received midmonth then points will be awarded immediately therefore contributing to the driver status in that month. On the last day of each month, the driver's telematic data or a telematic score will be received and points award points accordingly.

The driver status and individual driver telematic scores are advantageously communicated to the principle drivers via the communication network 24. In addition, reminders are sent out when a roadworthy check or tire check is required via the communication network 24.

The fuel refund to the driver is in this embodiment altered depending on the driver's compliance with the program. In one example, this takes the form of limiting the refund to the number of driver points earned in a month. Alternatively or in addition, the refund could be increased or reduced based on the driver status level achieved in a month. Alternatively or in addition, the refund could be increased or reduced by a percentage amount which is determined by the driver's compliance with the program.

In any event, once the fuel refund has been determined, the rewards module 22 then effects the reward. In one example embodiment this could be done by communicating with a financial institution via the communications network 24, and instructing the financial institution to implement the reward. Typically the financial institution will be instructed to pay an amount of funds to the driver, which will be paid into either a bank account of the driver or into their credit or debit card that they use to purchase fuel, for example.

It will be appreciated that the methodologies described above could be implemented by an insurer that insures motor vehicles. Alternatively, these methods could be implemented by a third party. In the case of the methodologies being implemented by an insurance company, various insurance plans are known to insure motor vehicles in the event of an accident or against theft, for example.

These insurance plans typically have the owner of the motor vehicle as the insured person. The insured person pays a premium to the insurer to insure the motor vehicle against an insured event such as an accident or against theft, for example. The quantum of the premium is usually determined using a number of factors such as the value of the motor vehicle and in certain cases the driver's age. The above factors are also used to determine an excess which is a first amount paid by the insured person in the event of a claim before the insurer pays towards the claim.

Thus it will be appreciated that a method of rewarding the driver thereby motivating them to improve their driver behaviors including their driving skills and to look after their motor vehicle is disclosed. This helps ensure the driver's safety while at the same time results in reduced claims to the insurer and is therefore beneficial to all parties.

Computer System

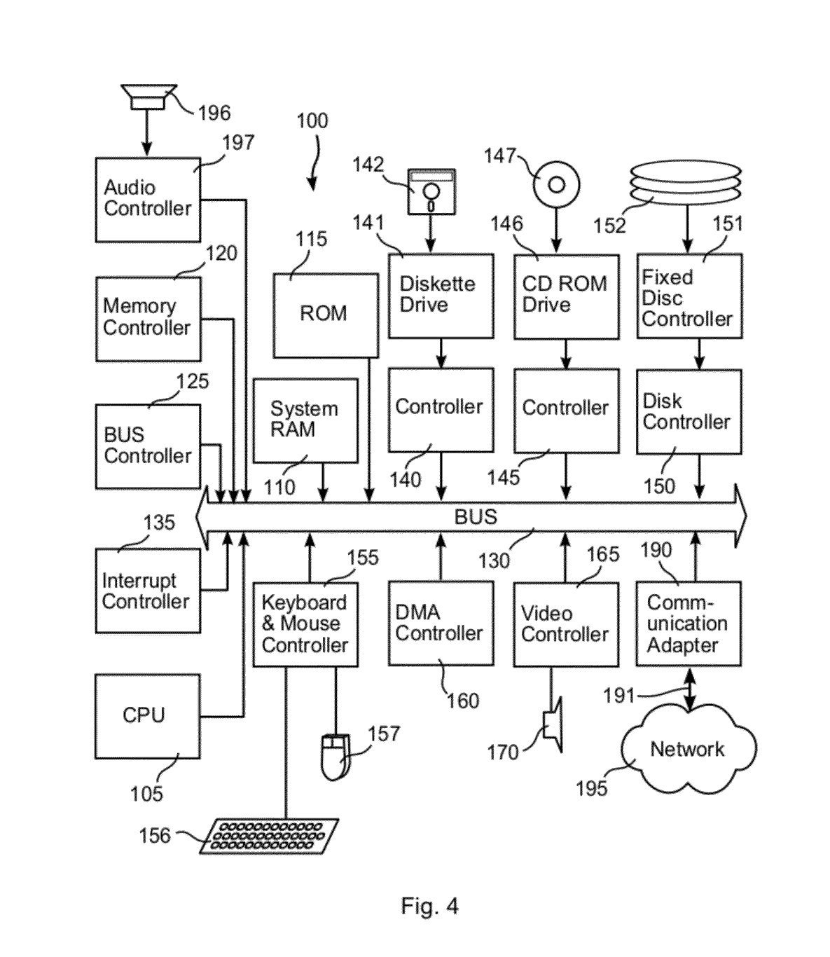

FIG. 4 illustrates the system architecture for a computer system 1000 such as a server, work station or other processor on which the disclosure may be implemented. The exemplary computer system of FIG. 15 is for descriptive purposes only. Although the description may refer to terms commonly used in describing particular computer systems, the description and concepts equally apply to other systems, including systems having architectures dissimilar to FIG. 4.

Computer system 1000 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 1000. A bus controller 125 is provided for controlling bus 130. An interrupt controller 135 is used for receiving and processing various interrupt signals from the system components.

Mass storage may be provided by diskette 142, CD or DVD ROM 147, flash or rotating hard disk drive 152. Data and software, including software 400 of the disclosure, may be exchanged with computer system 1000 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150. It should be understood that other storage, peripheral, and computer processing means may be developed in the future, which may advantageously be used with the disclosure.

User input to computer system 1000 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 1000 also includes a communications adapter 190 which allows the system to be interconnected to a local area network (LAN) or a wide area network (WAN), schematically illustrated by bus 191 and network 195.

Operation of computer system 1000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 105 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety. There are many different features to the present disclosure and it is contemplated that these features may be used together or separately. Unless mention was made above to the contrary, it should be noted that all of the accompanying drawings are not to scale. Thus, the invention should not be limited to any particular combination of features or to a particular application of the disclosure. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

1. A method of managing a fuel related reward program, the method including:
using a computer to execute software stored on non-transitory medium, the software configured for—
receiving data including an amount of fuel to which a fuel benefit will apply and a nominated price for the fuel for a future period from a driver of a motor vehicle;
during the future period or after the future period has passed, receiving purchase data including a quantity of fuel purchased by the driver during the period and a price paid for the purchased fuel;
comparing the purchase price with the nominated price; and
if the purchase price is higher than the nominated price causing a refund to the driver of at least a portion of the difference between the purchase price and the nominated price for at least some of the quantity of fuel purchased.

2. The method according to claim 1, the software further configured for:
receiving data including information relating to the compliance of the driver in a plurality of program areas related to motor vehicle driver behaviors and storing the data in a database;
awarding points to the driver wherein the points allocated are related to the compliance of the driver in the program areas; and
using the points allocated to alter the amount of the refund to the driver.

3. The method according to claim 2, wherein the plurality of program areas includes at least some of vehicle maintenance, driver education, vehicle insurance claims and driving performance.

4. The method according to claim 2 wherein the plurality of program areas includes all of vehicle maintenance, driver education, vehicle insurance claims and driving performance.

5. The method according to claim 3, wherein the program area of vehicle maintenance includes one or more of servicing the vehicle, checking the vehicle, and checking the vehicle tires.

6. The method according to claim 3, wherein the program area of driver education includes one or more of a driving course, a driver assessment, a periodic driver quiz, and a carbon footprint calculation.

7. The method according to claim 3, wherein the program area of vehicle insurance claims includes the number of claim free years.

8. The method according to claim 3, wherein the program area of driving score includes monitoring the manner in which the motor vehicle is driven.

9. A system for managing a driver rewards program, the system including:
a computer to execute software stored on non-transitory medium, the software configured for—
receiving data including an amount of fuel to which a fuel benefit will apply and a nominated future price for the fuel for a future period from a driver of a motor vehicle, and during the future period or after the future period has passed, receiving purchase data including a quantity of fuel purchased by the driver during the period and a price paid for the purchased fuel; and
comparing the purchase price with the nominated price and if the purchase price is higher than the nominated price calculating a refund for the driver of at least a portion of the difference between the purchase price and the nominated price for at least some of the quantity of fuel purchased.

10. The system according to claim 9, wherein the software is further configured for:
receiving data relating to the compliance of a driver in a plurality of program areas related to motor vehicle driver behaviors; and
awarding points to the driver wherein the points allocated are related to the compliance of the driver in the program areas and to use the points allocated to alter the amount of the refund to the driver.

11. The system according to claim 10, wherein the points allocated are used to determine a driver status, and wherein the driver status is used to alter the amount of the refund to the driver.

12. The system according to claim 10, wherein the plurality of program areas includes at least some of vehicle maintenance, driver education, vehicle insurance claims and driving performance.

13. The system according to claim 10, wherein the plurality of program areas includes all of vehicle maintenance, driver education, vehicle insurance claims and driving performance.

14. A system according to claim 10, wherein the program area of vehicle maintenance includes one or more of servicing the vehicle, checking the vehicle and checking the vehicles tires.

15. The system according to claim 10, wherein the program area of driver education includes one or more of a driving course, a driver assessment, a periodic driver quiz, and a carbon footprint calculation.

16. The system according to claim 10, wherein the program area of vehicle insurance claims includes the number of claim free years.

17. The system according to claim 10, wherein the program area of driving score includes monitoring the manner in which the motor vehicle is driven.

18. The system according to claim 10, wherein the software is further configured for:
obtaining driver data from a device associated with a motor vehicle; and
analysing the data to determine the manner in which the motor vehicle has been driven for a past period.
